(19) United States
(12) Patent Application Publication
(10) Pub. No.: US 2018/0370448 A1
(43) Pub. Date: Dec. 27, 2018

(54) Roof Rack System for a Vehicle and Its Associated Method of Installation

(71) Applicant: George J. Schafer, JR., Pennington, NJ (US)

(72) Inventor: George J. Schafer, JR., Pennington, NJ (US)

(21) Appl. No.: 15/872,226

(22) Filed: Jan. 16, 2018

Related U.S. Application Data
(60) Provisional application No. 62/446,996, filed on Jan. 17, 2017.

(51) Int. Cl. B60R 9/058

(52) U.S. Cl. CPC B60R 9/058; B60R 9/10

(57) ABSTRACT

A roof rack system for a vehicle that has roll bars that are selectively covered with a removable or retractable roof. A first mounting bar attaches to a first roll bar of the vehicle. The second mounting bar attaches to the second roll bar. An optional third mounting bar may be used. Both the first mounting bar and the second mounting bar are held within a gap space between the roll bars and the soft top roof. When the soft top roof is retracted, a plurality of mounting accessories can be selectively attached to both the first mounting bar and the second mounting bar. The mounting accessories can have different shapes.

### RELATED APPLICATIONS

This application claims priority of provisional patent application No. 62/446,996, filed Jan. 17, 2017.

### BACKGROUND OF THE INVENTION

### 1. Field of the Invention

In general, the present invention relates to roof racks and cargo racks that are designed to attach to the roof of a vehicle, such as a sports utility vehicle or a pickup truck. More particularly, the present invention relates to roof racks and cargo racks that attach directly to the roll frame of a vehicle that has a removable or retractable roof.

### 2. Prior Art Description

Many vehicles, such as the Jeep® Wrangler®, have roof system that is either removable or retractable. This enables the vehicle to be fitted with either a soft top roof, a hard top roof, or a hybrid roof with sliding panels depending upon the preferences of the owner. Since the roof system is removable and/or retractable, it is not integrated into the structural framework of the vehicle. In order to keep the vehicle safe and stable, the vehicle is typically designed with roll bars that extend laterally across the top of the vehicle. The roll bars are part of a safety framework that protects the occupants of the vehicle, should the vehicle roll over or be involved in a collision. In addition to providing safety, the roll bars of the vehicle also serve as anchors and supports to the roofing system, wherein the soft top or hard top pass over the roll bars.

In such a vehicle, a problem occurs when a person attempts to attach a roof rack or some other cargo rack to the top of the vehicle. If the roof rack is attached directly to the roll bars, then the presence of the rack prevents the soft top or hard top from being installed. The vehicle must therefore remain as a convertible for as long as the roof rack is in place. Such prior art systems are exemplified by U.S. Patent Application Publication No. 2012/0193380 to McMurtrie and U.S. Pat. No. 6,152,339 to Kreisler. If the roof rack is installed atop the soft top or hard top, then holes must be formed in the soft top or hard top. This damages the roofing system and promotes leaking and tearing. Such prior art systems are exemplified by U.S. Pat. No. 4,538,752 to Welter.

The only alternative is to create brackets that attach to the framework of the vehicle at points around the periphery of the roofing system. Such prior art systems are exemplified by U.S. Patent No. 2011/0101056 to Barkey and U.S. Patent Application Publication No. 2014/0069971 to Van Kaathoven. The problem with these systems is that their presence prevents the easy removal or application of the roofing system. Also, such prior art systems tend to adversely alter the aesthetics of the vehicle.

A need therefore exists for a roof rack system for vehicles with removable or retractable roofs, wherein the roof rack system transfers loads to the roll bars of the vehicle without adversely affecting the functionality of the existing roofing system. A need also exists for a roof rack system that does not detract from the overall aesthetics of the vehicle.

These needs are met by the present invention as described and claimed below.

### SUMMARY OF THE INVENTION

The present invention is a roof rack system for a vehicle that has roll bars that are selectively covered with a removable or retractable roof. When the roof is installed, the roof extends over the roll bars. Gap spaces exists between the roof and the roll bars.

The roof rack system utilizes at least a first mounting bar and a second mounting bar. Both the first mounting bar and the second mounting bar support a plurality of receptacles. The first mounting bar attaches to the first roll bar. The second mounting bar attaches to the second roll bar. Both the first mounting bar and the second mounting bar are held within the gap space between the roll bars and the roof. In this manner, the presence of the mounting bars do not interfere with the operation of the roof.

One or more of the mounting bars may also have the ability to deploy from a stored position, wherein the mounting bar does not interfere with the roof system when in its stored position.

When the roof of the vehicle is retracted, a plurality of mounting accessories can be selectively attached to both the mounting bars. The mounting accessories can have different shapes. However, each of the mounting accessories has a connector that can selectively engage any of the receptacles on the various mounting bars.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of an exemplary embodiment of a roof rack system being applied to the roll bars of a sports utility vehicle;

FIG. 2 is the same view as FIG. 1 with the roof rack assembly shown in an exploded perspective;

FIG. 3 is a top view of a first mounting bar from the exemplary roof rack assembly;

FIG. 4 is a front view of a first mounting bar from the exemplary roof rack assembly;

FIG. 5 is a top view of a second mounting bar from the exemplary roof rack assembly;

FIG. 6 is a front perspective view of a second mounting bar from the exemplary roof rack assembly;

FIG. 7 is a partially fragmented view of the roof rack assembly installed under a soft top roof of a sports utility vehicle;

FIG. 8 is a front view of the exemplary mounting accessories shown with a fragmented mounting bar;

FIG. 9 shows a modified mounting bar assembly that has brackets to mount to a hard top and optional lights;

FIG. 10 shows a front view of a third mounting bar for use with the exemplary roof rack assembly; and

FIG. 11 shows the modified mounting bar assembly of FIG. 10 shown in conjunction with an exemplary sports utility vehicle.

### DETAILED DESCRIPTION OF THE DRAWINGS

Although the present invention roof rack system can be adapted for use in many types of sports utility vehicles and pickup trucks that have exposed roll bars or retractable roof systems, the roof rack system is especially well suited for use on a Jeep® Wrangler® sports utility vehicle. Accordingly, the present invention roof rack system is presented in an exemplary embodiment where it is configured for use on a Jeep® Wrangler® sports utility vehicle. The illustrated embodiment is selected in order to set forth one of the best modes contemplated for the invention. However, the illustrated Jeep® vehicle is intended to be representative of any vehicle that has a retractable or removable roof and contains roll bars. The illustrated embodiment is merely exemplary and should not be considered a limitation when interpreting the scope of the appended claims.

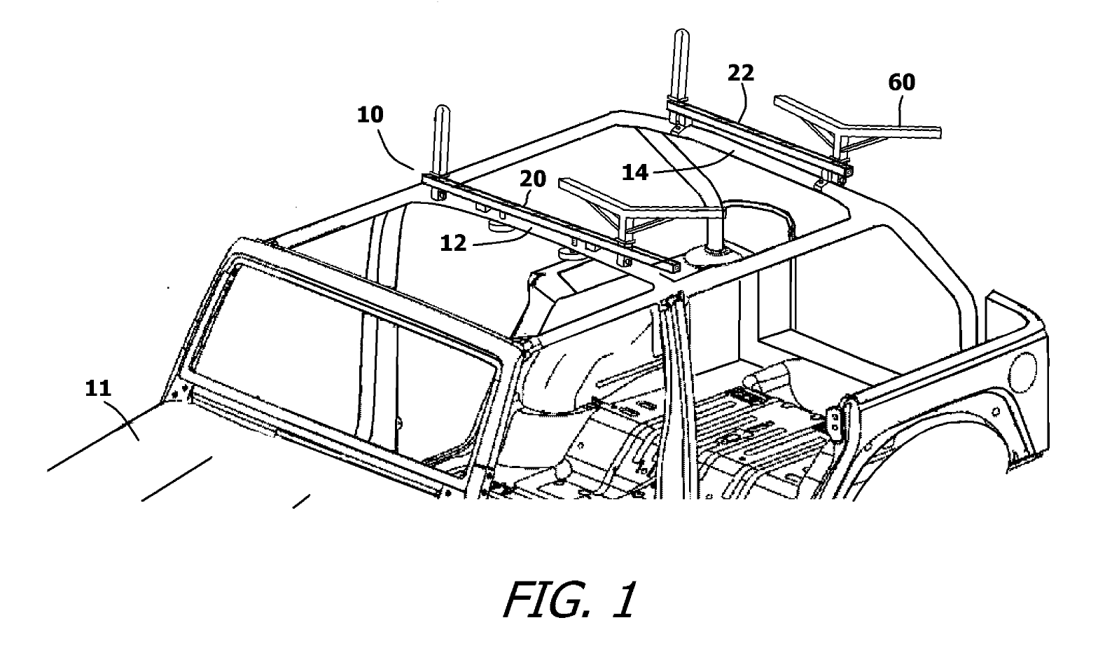

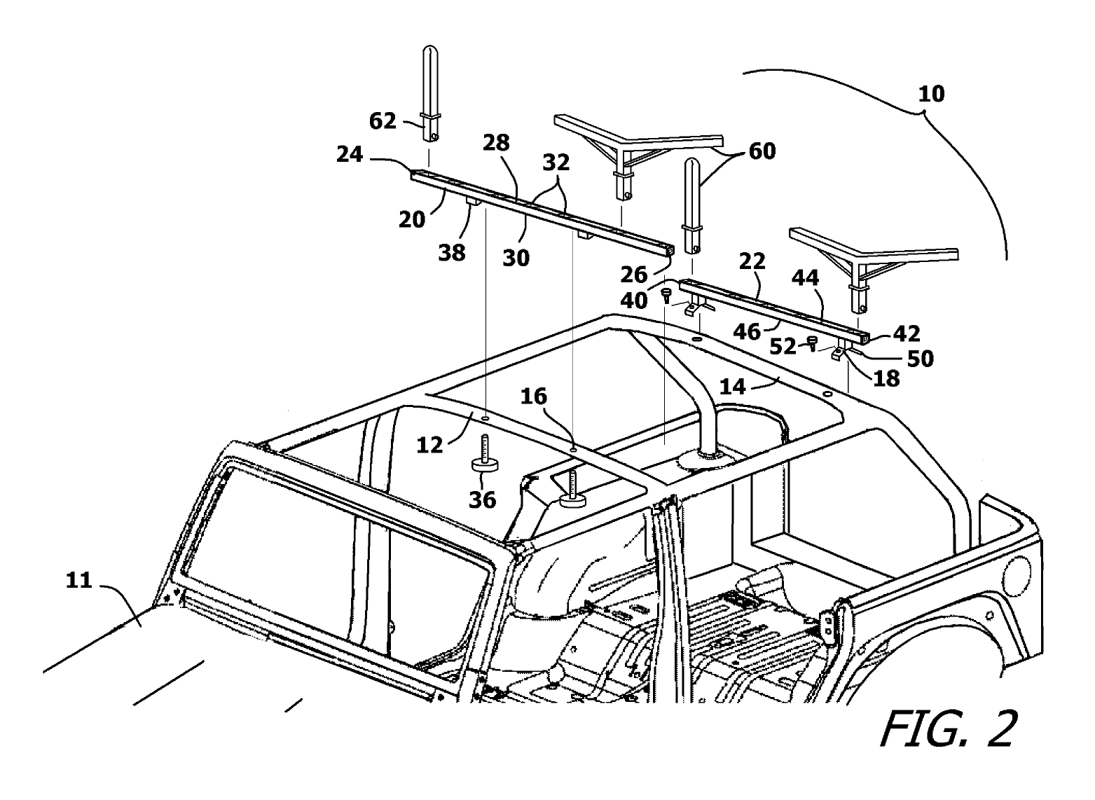

Referring to FIG. 1 and FIG. 2, a roof rack system 10 is shown in conjunction with an exemplary embodiment of a Jeep® Wrangler® sports utility vehicle 11. In particular, a modern four door model of the Jeep® Wrangler® is shown. Such a sports utility vehicle 11 has a front roll bar 12 and a rear roll bar 14. The roll bars 12, 14 are often referred to as sports bars by owners of such sport utility vehicles 11. There are bolt holes 16, 18 in both the front roll bar 12 and the rear roll bar 14. The bolt holes 16, 18 are used to attach various components to the roll bars 12, 14. More particularly, the rear bolt holes 18 are used in the application of a soft top roofing system and the front bolt holes 16 are used in the application of a hard top roofing system. The front bolt holes 16 and the rear bolt holes 18 are standard equipment that are provided by the manufacturer of the sports utility vehicle 11. It will be understood that depending upon the make and model of the vehicle, holes or other mounting features may be presented at various points on the roll bars.

The roof rack system 10 of the present invention includes two primary mounting bars 20, 22. The first mounting bar 20 attaches to the front roll bar 12. The second mounting bar 22 attaches to the rear roll bar 14. When mounted, the first mounting bar 20 and the second mounting bar 22 are parallel and are mounted at a common elevation. Accordingly, the two mounting bars 20, 22 serve as two parallel roof racks.

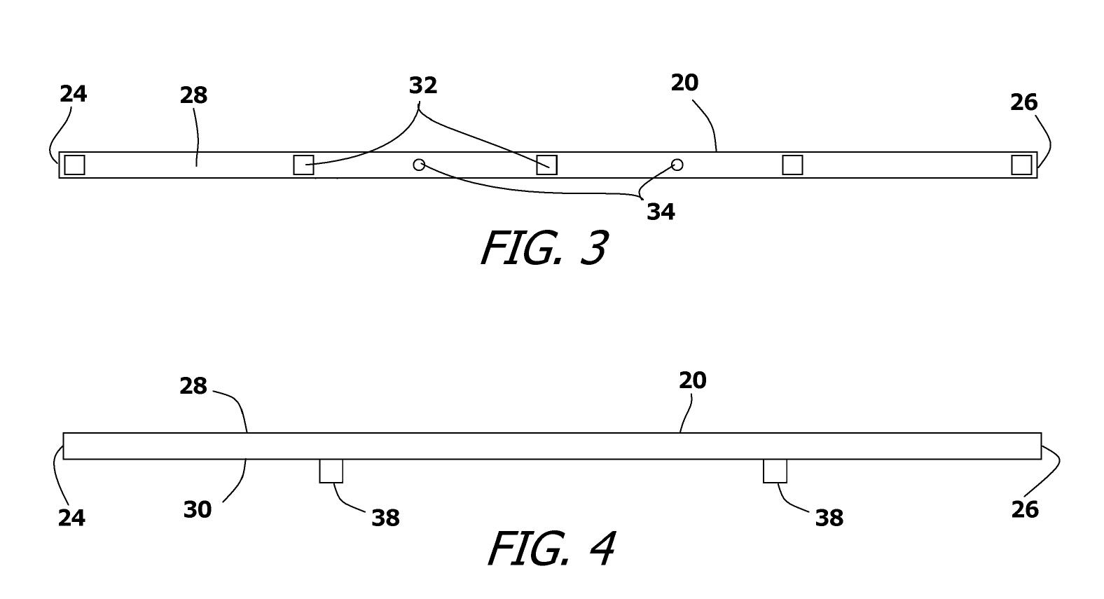

Referring to FIG. 3 and FIG. 4 in conjunction with FIG. 1 and FIG. 2, it can be seen that the first mounting bar 20 has a first end 24 and an opposite second end 26. The first mounting bar 20 is preferably straight between the first end 24 and the second end 26. The length between the first end and the second end is a matter of design choice. However, it is preferred that the distance be at least four feet wide so that the mounting bar 20 can accommodate a load as wide as a four-by-eight panel.

In the illustrated embodiment, the first mounting bar 20 has a square cross-sectional profile. However, it will be understood that the first mounting bar 20 can be round, rectangular, or have any other cross-sectional shape that provides structural integrity.

Regardless of the selected cross-sectional shape, the first mounting bar 20 will have a top surface 28 and an opposite bottom surface 30. When mounted to a sports utility vehicle 11, the bottom surface 30 of the first mounting bar 20 will face toward the sports utility vehicle 11 and the top surface 28 will face vertically away from the sports utility vehicle 11.

A plurality of receptacles 32 are formed along the length of the first mounting bar 20. There is a receptacle 32 positioned at both the first end 24 of the first mounting bar 20 and at the second end 26 of the first mounting bar 20. The remaining receptacles 22 are interposed periodically between the first end 24 and the second end 26. The number and spacing of the receptacles 32 is a matter of design choice but is preferably greater than one.

In the illustrated embodiment, each of the receptacles 32 is merely a shaped hole that passes through the structure of the first mounting bar 20 from the top surface 28 to the bottom surface 30. Such a construction is merely exemplary. Receptacles 32 need not pass through the first mounting bar 20.

Rather, receptacles 32 in the form of short open-ended tubes can be affixed to the sides of the first mounting bar 20, if preferred as an alternative.

Two threaded bores 34 are formed in the bottom surface 30 of the first mounting bar 20. The two threaded bores 34 are spaced to match the bolt holes 16 that exist on the front roll bar 12 of the sports utility vehicle 11. In this manner, mechanical fasteners 36 can be extended through the bolt holes 16 to engage the threaded bores 34 in the first mounting bar 20. This mechanically interconnects the first mounting bar 20 to the front roll bar 12 of the sports utility vehicle 11. The front roll bar 12 of the sports utility vehicle 11 may have a slight curve to it, depending upon the make and model of the sports utility vehicle 11. Spacers 38 are attached to the bottom surface 30 of the first mounting bar 20. The spacers 38 contact the front roll bar 12 and ensure that the first mounting bar 20 is level as it is tightened in place. It will be understood that the threaded bores 34 can be substituted with simple bolt holes, wherein bolts with nuts are used to secure the first mounting bar 20 in place.

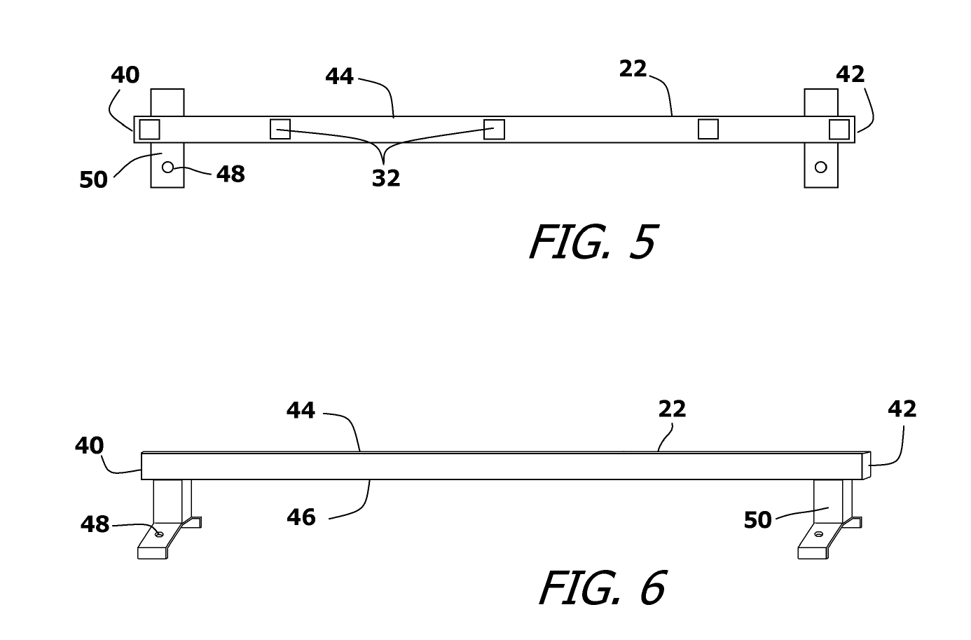

Referring to FIG. 5 and FIG. 6 in conjunction with FIG. 1 and FIG. 2, it can be seen that the second mounting bar 22 has a first end 40 and an opposite second end 42. The second mounting bar 22 is preferably straight between the first end 40 and the second end 42. In the illustrated embodiment, the second mounting bar 22 has a square cross-sectional profile. However, it will be understood that the second mounting bar 22 can be round, rectangular or have any other cross-sectional shape. Regardless of the selected cross-sectional shape, the second mounting bar 22 will have a top surface 44 and an opposite bottom surface 46. When mounted to a sports utility vehicle 11, the bottom surface 46 of the second mounting bar 22 will face toward the sports utility vehicle 11 and the top surface 44 will face vertically away from the sports utility vehicle 11.

A plurality of receptacles 32 are formed along the length of the second mounting bar 22. The receptacles 32 on the second mounting bar 22 are the same as the receptacles 32 on the first mounting bar 20, thus the same reference number is used. There is a receptacle 32 at both the first end 40 and the second end 42 of the second mounting bar 22. The remaining receptacles 32 are interposed periodically between the first end 40 and the second end 42. The number and spacing of the receptacles 32 is a matter of design choice but is preferably between greater than one.

In the illustrated embodiment, each of the receptacles 32 is merely a hole that passes through the structure of the second mounting bar 22 from the top surface 44 to the bottom surface 46. Such a construction is merely exemplary. Receptacles 32 need not pass through the second mounting bar 22. Rather, receptacles 32 can be affixed to the sides of the second mounting bar 22.

Two brackets 50 extend from the bottom surface 46 of the second mounting bar 22. The brackets 50 are sized and shaped to conform to a section of the rear roll bar 14 of the sports utility vehicle 11. Threaded bores 48 are formed into the brackets 50. The brackets 50 position the threaded bores 48 to align with the bolt holes 18 on the rear roll bar 14 of the sports utility vehicle 11. In this manner, mechanical fasteners 52 can be extended through the bolt holes 18 to engage the threaded bores 48 in the brackets 50. This mechanically interconnects the second mounting bar 22 to the rear roll bar 14 of the sports utility vehicle 11. It will be understood that the threaded bores 48 can be substituted with simple bolt holes, wherein bolts with nuts are used to secure the second mounting bar 22 in place.

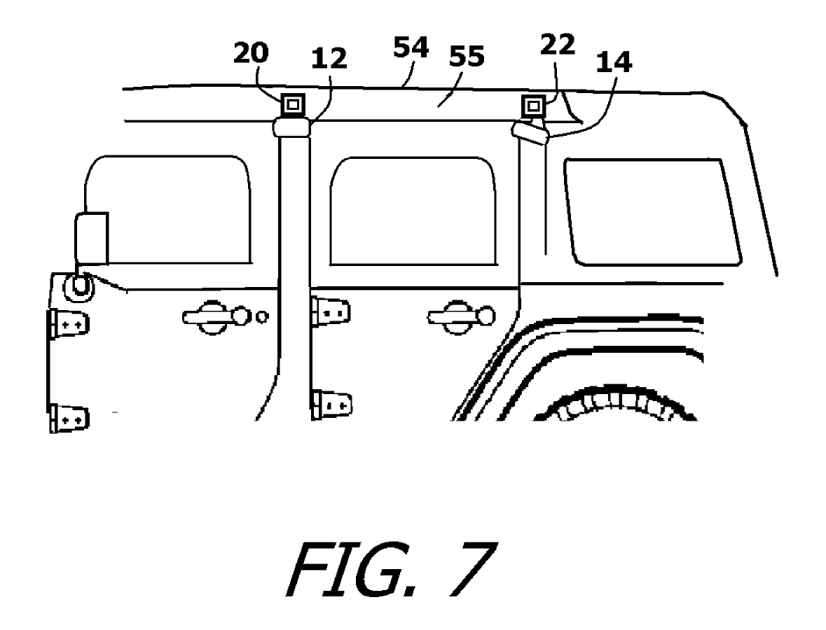

Referring to FIG. 7, it will be understood that when the first mounting bar 20 and the second mounting bar 22 are attached to the sports utility vehicle 11, the two mounting bars 20, 22 are parallel and are oriented in a common horizontal plane. Furthermore, the two mounting bars 20, 22 are very closely positioned above the two roll bars 12, 14. The mounting bars 20, 22 have a preferred thickness of under five centimeters. This is smaller than the gap space 66 that occurs between a soft top roof 54 and the roll bars 12, 14. As a consequence, both the mounting bars 20, 22 can be left in place, mounted to the roll bars 12, 14, without effecting the ability to close a soft roofing system over the roll bars 12, 14.

The soft top roof 54 can, therefore, be opened and closed in a traditional manner with the mounting bars 20, 22 set in place.

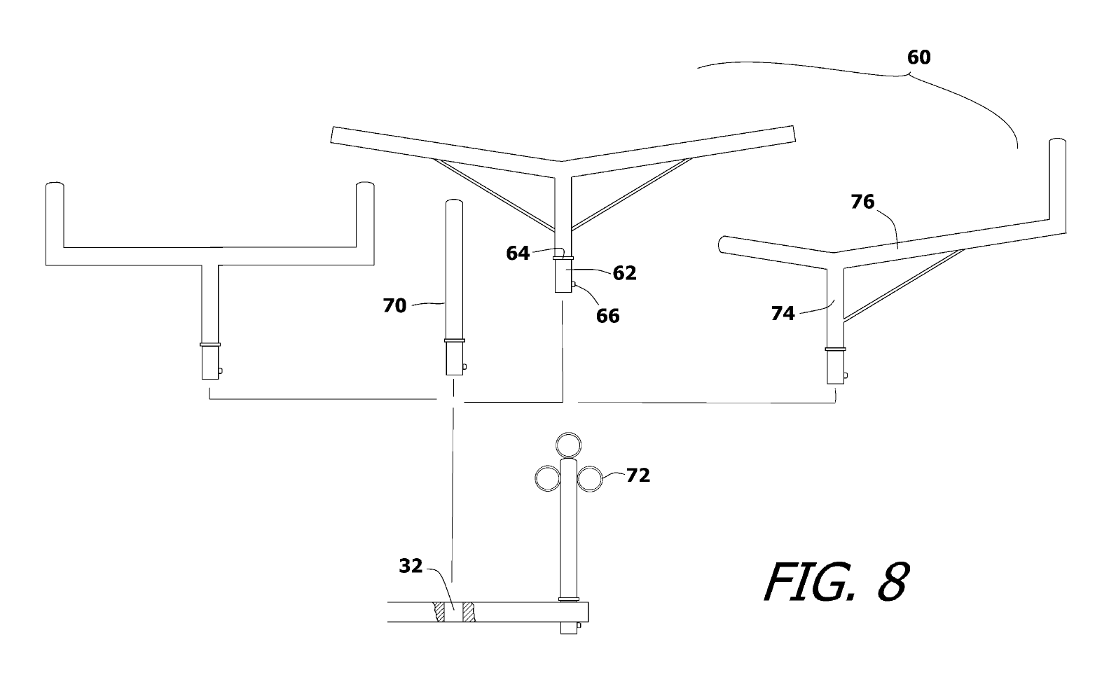

Referring to FIG. 8 in conjunction with FIG. 1 and FIG. 7, it will be understood that in order to utilize the roof rack system 10, the mounting bars 20, 22 are mounted in place. If a soft top roof 54 is being used, it is retracted to expose the mounting bars 20, 22. Each of the mounting bars 20, 22 contain receptacles 32. The receptacles 32 are the same on both the first mounting bar 20 and the second mounting bar 22. A plurality of mounting accessories 60 are available, wherein each of the mounting accessories 60 can be attached to any of the receptacles 32. All of the mounting accessories 60 have a common connector 62. The connector 62 is shaped to pass into any receptacle 32. The connector 62 has a shape that can be received in the receptacle 32 but cannot rotate once within the receptacle 32. There is a stop 64 formed on the connector 62 to limits the passing of the connector 62 onto a receptacle 32. A locking mechanism 66, such as a detent, is provided to prevent each connector 62 from inadvertently exiting a receptacle 32.

The mounting accessories 60 can have many specialized configurations for specialized purposes. The simplest of the mounting accessories 60 is a post 70. The post 70 extends vertically from any of the receptacles 32 on the mounting bars 20, 22. The posts 70 can have any lengths. Additionally, posts 70 can have loops 72 to help with the attachment of ropes and other strapping elements.

Mounting accessories 60 can also be specialized for specific carrier tasks, such as kayak carriers, bicycle carriers and the like. Such specialized mounting accessories 60 have connectors 62 coupled to a shaft 74. The shaft 74 elevates a U-shaped frame or some other yoke 76 that is specifically sized and shaped to hold a particular item. Since the receptacles 32 are located on the mounting bars 20, 22 at periodic points, the mounting accessories 60 can be positioned to customize the roof rack system 10 to the particular shape and size of the load being carried.

Referring now to all figures, it will be understood that in order to use the roof rack system 10, the roll bars 12, 14 on the sports utility vehicle 11 are exposed. This may involve retracting or removing a soft top roof 54. Once the roll bars 12, 14 are exposed, the mounting bars 20, 22 are attached. If not immediately needed to carry a load, the soft top roof 54 can be closed directly over the mounting bars 12, 14.

When a load is to be carried, the mounting bars 20, 22 are again exposed by retracting the soft top roof 54. Mounting accessories 60 are selected for the load and are inserted into the appropriate receptacles 32 on the mounting bars 20, 22. The load is then tied in place using traditional strapping. The mounting bars 20, 22 transfer the weight of the load directly to the roll bars 12, 14 of the sports utility vehicle 11. Once the load is transported and unloaded, the mounting accessories 60 can be removed and stored. The mounting bars 20, 22 can remain in place as the soft top roof 54 is deployed.

In the first illustrated embodiment, the roof rack system 10 is shown applied directly to the roll bars 12, 14 of a vehicle 11 with its roof either retracted or removed. Using a minor modification, the mounting bars 20, 22 can be configured so that they can be used on a vehicle with an integrated metal roof or on a vehicle with a hard roof installed.

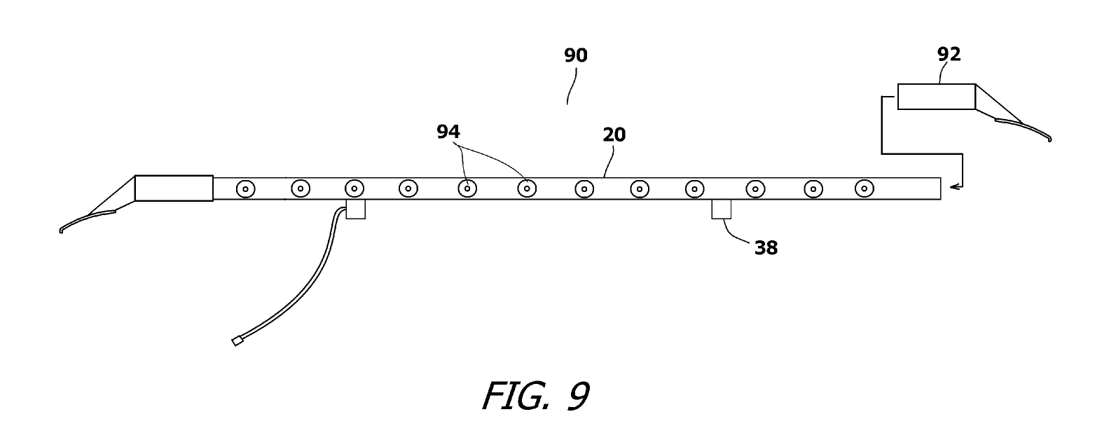

Referring to FIG. 9, a modified mounting bar assembly 90 is shown. The modified mounting bar assembly 90 utilizes the first mounting bar 20 of the earlier embodiments. The first mounting bar 20 is modified with mounting brackets 92. The mounting brackets 92 attach to the two ends of the first mounting bar 20. The mounting brackets 92 are shaped and sized to engage the edge of a metal roof or a hard top roof, therein joining the first mounting bar 20 to such a roof. When engaged to a roof with the mounting brackets 92, the spacers 38 preferably rest upon the roof and help spread the weight of any load across the roof above the roll bar.

It will be understood that the mounting brackets 92 used to modify the first mounting bar 20 can also be used to modify the second mounting bar, therein enabling both mounting bars to be affixed to a removable hard top roof or a fixed metal roof of a vehicle.

In the embodiment of FIG. 9, the modified mounting bar assembly 90 is further modified with an array of lights 94. Since the modified mounting bar assembly 90 is mounted atop a vehicle, it can be used to hold the array of lights 94. The array of lights 94 is integrated into the mounting bar 20. In this way, the lights 94 do not interfere with the ability of the modified mounting bar assembly 90 to support a load. The array lights 94 can contain traditional white or colored lights for use in forward, rearward or lateral illumination. By placing the array of lights 94 in the modified mounting bar assembly 90, the array of lights 94 can be quickly removed or covered with a soft top roof in jurisdictions where roof lights are restricted to commercial vehicles. Of course, the array of lights 94 in the modified mounting bar 90 can be colored lights for use on emergency vehicles.

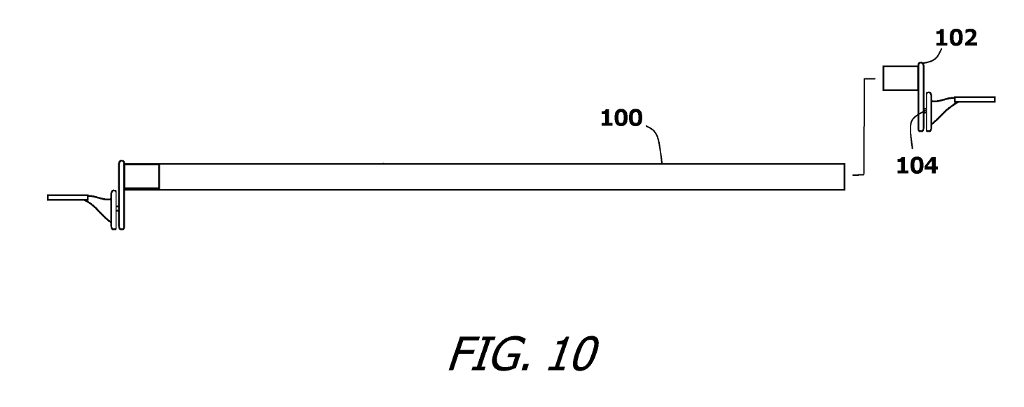

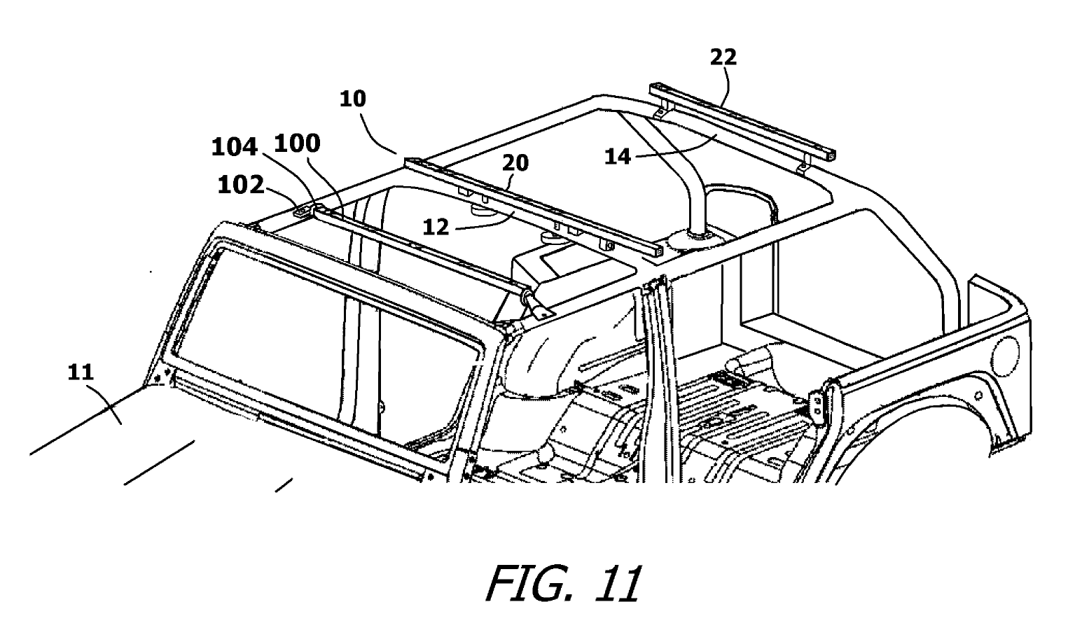

In all embodiments previously illustrated, two mounting bars have been added to the roof of a vehicle in order to support a load atop the vehicle. It will be understood, that additional mounting bars in excess of two can be used if required or desired. Referring to FIG. 10 and FIG. 11, an exemplary third mounting bar 100 is illustrated. The third mounting bar 100 can be attached to a third roll bar of the vehicle, if present. Alternatively, the third mounting bar 100 can have brackets 102 that attach directly to the side frame of the vehicle. The brackets 102 may be rigid, or may contain a hinge joint 104 that enables the third mounting bar 106 to be moved. In this manner, the third mounting bar 106 can be rotated down into a retracted position or rotated up into a deployed position, while remaining mounted to the vehicle. The ability of the third mounting bar 100 to move to a retracted position is important in vehicles where the presence of the third mounting bar 100 near the windshield may interfere with the proper attachment of a removable or retractable roofing system.

It will be understood that the embodiments of the present invention that are illustrated and described are merely exemplary and that a person skilled in the art can make many variations to these embodiments. All such embodiments are intended to be included within the scope of the present invention as defined by the claims.

What is claimed is:

1. In a vehicle having a first roll bar and a second roll bar, wherein bolt holes are formed in said first roll bar and said second roll bar, a method of connecting a roof rack to said first roll bar and said second roll bar, said method comprising the steps of:
providing a first mounting bar, wherein said first mounting bar supports a first plurality of receptacles;
providing a second mounting bar, wherein said second mounting bar supports a second plurality of receptacles;
providing mounting accessories, wherein each of said mounting accessories is configured to selectively engage any one of said first plurality of receptacles and said second plurality of receptacles;
providing mechanical fasteners;
attaching said first mounting bar to said first roll bar with said mechanical fasteners, wherein said mechanical fasteners extend through said bolt holes in said first roll bar;
attaching said second mounting bar to said second roll bar, wherein said second roll bar is oriented parallel to said first roll bar;
connecting at least one of said mounting accessories to at least one of said first plurality of receptacles, and
connecting at least one of said mounting accessories to at least one of said second plurality of receptacles.

2. The method according to claim 1, further including providing a third mounting bar and attaching said third mounting bar to said vehicle, wherein said first mounting bar, said second mounting bar and said third mounting bar are parallel.

3. The method according to claim 1, wherein providing said second mounting bar includes providing a second mounting bar with brackets that extend from said second mounting bar.

4. The method according to claim 2, wherein attaching said second mounting bar to said second roll bar, includes connecting said brackets to said second roll bar with said mechanical fasteners.

5. The method according to claim 1, wherein providing a first mounting bar includes providing a first mounting bar with a first end, an opposite second end, a top surface and an opposite bottom surface, wherein said first plurality of receptacles are periodically interposed between said first end and said second end.

6. The method according to claim 5, further including providing spacers that extend from said bottom surface of said first mounting bar, wherein said spacers separate said first mounting bar from said first roll bar when said first mounting bar is attached to said first roll bar.

7. The method according to claim 1, wherein attaching said first mounting bar to said first roll bar positions said first mounting bar no higher than five centimeters above said first roll bar.

8. The method according to claim 1, wherein providing mounting accessories includes providing mounting accessories configured as vertical posts.

9. The method according to claim 1, wherein providing mounting accessories includes providing mounting accessories configured with vertical shafts and at least one lateral arm that extends from said vertical shaft.

10. The method according to claim 1, wherein providing said first mounting bar, includes providing said first mounting bar with said first plurality of receptacles formed as holes that extend through said first mounting bar.

11. The method according to claim 1, wherein providing said second mounting bar includes providing said second mounting bar with said second plurality of receptacles formed as holes that extend through said second mounting bar.

12. In a vehicle having a first roll bar, a second roll bar, and a retractable soft top roof, wherein a gap space exists between said first roll bar, said second roll bar and said retractable soft top roof, a method of connecting a roof rack to said first roll bar and said second roll bar, said method comprising the steps of:
attaching a first mounting bar to said first roll bar within said gap space, wherein said first mounting bar supports a first plurality of receptacles;
attaching a second mounting bar to said second roll bar within said gap space, wherein said second mounting bar supports a second plurality of receptacles; and
providing at least one mounting accessory that can selectively attach to any one of said first plurality of receptacles and said second plurality of receptacles when said soft top roof is retracted.

13. The method according to claim 12, wherein said first roll bar has bolt holes formed therein and said first mounting bar is attached to said first roll bar using mechanical fasteners that pass into said bolt holes.

14. The method according to claim 12, wherein said second roll bar has bolt holes formed therein and said second mounting bar is attached to said second roll bar using mechanical fasteners that pass into said bolt holes.

15. The method according to claim 12, wherein said second mounting bar has brackets that extend from said second mounting bar, wherein attaching said second mounting bar to said second roll bar includes attaching said brackets to said second roll bar.

16. The method according to claim 12, wherein said first mounting bar has a first end, an opposite second end, a top surface and an opposite bottom surface, wherein said first plurality of receptacles are periodically interposed between said first end and said second end.

17. The method according to claim 16, further including providing spacers interposed between said first mounting bar and said first roll bar, wherein said spacers separate said first mounting bar from said first roll bar when said first mounting bar is attached to said first roll bar.

18. In a vehicle having a removable roof system and at least one roll bar, a method of connecting a roof rack to said vehicle, said method comprising the steps of:
providing a plurality of roll bars, wherein each of said role bars supports receptacles;
providing mounting accessories, wherein each of said mounting accessories is configured to selectively engage any one of said receptacles;
providing mechanical fasteners;
attaching at least one of said plurality of roll bars to said at least one roll bar with said mechanical fasteners;
connecting at least one of said mounting accessories to at least one of said receptacles.

19. The method according to claim 18, wherein providing a plurality of mounting bars includes providing two mounting bars in parallel positions.

20. The method according to claim 18, wherein providing a plurality of mounting bars includes providing three mounting bars in parallel positions.
